(19) United States
(12) Patent Application Publication
(10) Pub. No.: US 2012/0257243 A1
(43) Pub. Date: Oct. 11, 2012

(54) INFORMATION PROCESSING APPARATUS, PRINT CONTROL METHOD, AND STORAGE MEDIUM

(75) Inventor: Hiroshi Kai, Tokyo (JP)

(73) Assignee: CANON KABUSHIKI KAISHA, Tokyo (JP)

(21) Appl. No.: 13/438,278

(22) Filed: Apr. 3, 2012

(30) Foreign Application Priority Data
Apr. 6, 2011 (JP) 2011-084719

(51) Int. Cl. G06K 15/02

(52) U.S. Cl. 358/1.14

(57) ABSTRACT

An issue is solved by determining whether print data includes identification information indicating that there is a target content to which a restriction on a number of times of printing is set, storing determination information for authorizing a reprinting process to be performed when an error occurring in printing the print data as authorization information of the reprinting process, and changing, if it is determined that the identification information is included, the determination information to information indicating not authorizing the reprinting process.

### BACKGROUND OF THE INVENTION

1. Field of the Invention

The present invention relates to an information processing apparatus, a print control method, and a storage medium.

2. Description of the Related Art

A conventional printing system generally includes a color printer capable of outputting in color, and a computer which controls the color printer and generates print data. An operating system (OS) operates on the computer, and various types of software operate thereon.

When the printing system is to print various types of document data (documents) created using an application, software such as the application, a printer driver, and the OS call functions according to a predetermined procedure to exchange the data, and generate various commands. The commands generated by such application, printer driver, and OS are then transferred to the printer, so that the printing system performs printing.

Japanese Patent No. 3209911 discusses a technique in which a computer in a printing system re-issues a print job, if a page is missing due to an error that has occurred while printing, and the printer skips the previously printed pages and reprints the missing page.

Japanese Patent Application Laid-Open No. 2002-259835 discusses a technique which restricts a number of times a predetermined content can be printed, and thus allows the predetermined content to be printed within the restricted number. Japanese Patent No. 4363162 discusses a method used in printing a document supplied from a server storing a document in which a charged portion described in a markup language has been marked. The method determines whether printing of the charged portion is completed based on the marks and controls a charging process.

If a document including the content whose number of times of printing is restricted is printed, an error may occur in the page including the content, so that the page may be is missed. In such a case, according to the above-described technique, the missing page is reprinted, and as a result, the printing system performs printing to exceed the restricted number of times of printing the content.

### SUMMARY OF THE INVENTION

The present invention is directed to more appropriately controlling printing of a content whose number of times of printing is restricted.

According to an aspect of the present invention, an information processing apparatus includes a determination unit configured to determine whether print data includes identification information indicating that there is a target content to which a restriction on a number of times of printing is set, a storing unit configured to store determination information indicating whether to authorize a reprinting process to be performed if an error occurs in printing of the print data as information indicating authorization of performing the reprinting process, and a changing unit configured to change, if the determination unit determines that the identification information is included, the determination information to information indicating not authorizing the reprinting process.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a configuration of a printing system.

FIG. 2 illustrates an example of an internal configuration of a printer driver.

FIG. 3 is an example of a flowchart illustrating a document editing and printing process.

FIG. 4 is an example of a flowchart illustrating a printing process.

FIG. 5 illustrates an example of a command.

FIG. 6 is an example of a flowchart illustrating a data transfer process.

FIG. 7 illustrates an example of the internal configuration of the printer driver.

FIG. 8 is an example of a flowchart illustrating the document editing and printing process.

FIGS. 9A and 9B illustrate examples of positional information and arrangement of charged contents in a page.

FIG. 10 is an example of a flowchart illustrating the printing process.

FIG. 11 is an example of the flowchart illustrating a page data output process.

FIGS. 12A and 12B illustrate examples of echo commands.

FIG. 13 is an example of a flowchart illustrating the data transfer process.

FIG. 14 is an example of a flowchart illustrating a data receiving process.

FIG. 15 is an example of a flowchart illustrating a print execution process.

FIGS. 16A and 16B illustrate examples of response commands.

### DESCRIPTION OF THE EMBODIMENTS

Various exemplary embodiments, features, and aspects of the invention will be described in detail below with reference to the drawings.

According to the present invention, a content, print data, and a job are defined as below.

A content is an element configuring a document created by a user using an application. Examples of the content are bitmap data, graphics data, character data, and the like. Print data is generated by converting the document created by the user using the application to a command understandable by the printer. A job is a unit by which the print data is managed in the printing system.

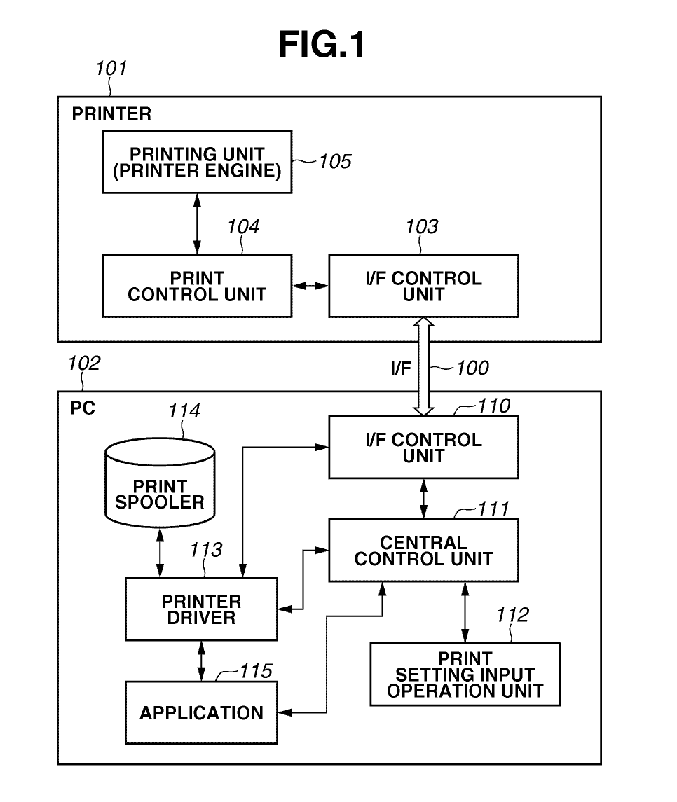

A first exemplary embodiment according to the present invention will be described in detail below with reference to FIGS. 1 to 6. FIG. 1 illustrates an example of a configuration of the printing system according to the present exemplary embodiment. Referring to FIG. 1, the printing system includes a printer 101 and a personal computer (PC) 102.

The printer 101 may be an inkjet type color printer which forms an image according to print data generated by the PC 102. According to the present exemplary embodiment, the printer is an inkjet type color printer. However, there is no limit on the type of the printer. Further, the printer 101 includes various functional units 103, 104, and 105.

An interface (I/F) control unit 103 performs an interface function of the printer 101. According to the present exemplary embodiment, a communication interface 100 conforms to a Universal Serial Bus (USB) standard, and the printer 101 includes a controller in a peripheral device side of the USB. In other words, the I/F control unit 103 controls the controller in the printer 101. For example, the I/F control unit 103 receives the print data.

Further, if there is a request from the PC 102 to acquire status information indicating an operation status of the printer 101, a status of an error that has occurred in the printer 101, and a communication status, the I/F control unit 103 transmits the status information to the PC 102. The operation status of the printer 101 includes such as, a printing progress status and a status of an ink remaining amount in the printer 101. Further, the status information is updated in the printer 101 at appropriate timing.

A print control unit 104 renders print data transmitted from the PC 102 in a printing unit 105 (i.e., a printer engine). According to the present exemplary embodiment, the print data transmitted from the PC 102 is data including a print control command which is subjected to image processing in the PC 102 based on print setting information including setting values of print setting items, such as a paper type and a paper size. In other words, the print control unit 104 controls the printing unit 105 according to the print data (i.e., the print control command).

More specifically, the print control unit 104 controls the printing unit 105 using the print data including binary data to be used in printing (i.e., intermediate data before binarization in some cases) and various commands for controlling an ink discharge amount, a number of passes, a print orientation, and a sheet conveying amount.

The printing unit 105 prints on a recording medium (i.e., a sheet) according to the print data rendered by the print control unit 104. Since the printer 101 is an inkjet type printer, the printer 101 forms an image by discharging ink.

The PC 102 which is an example of the information processing apparatus (i.e., a computer) generates the print data and controls the printer 101 connected thereto. Further, the PC 102 receives an instruction or an input from a user to add, change, or delete the print setting information.

The PC 102 includes various functional units 110, 111, 112, 113, 114, and 115. Further, the PC 102 includes the OS (not illustrated) for controlling the PC 102, and each functional unit is realized via the OS.

An I/F control unit 110 controls the interface function of the PC 102. According to the present exemplary embodiment, the PC 102 includes a controller in a host side of the USB. In other words, the I/F control unit 110 controls the controller, and includes the host function as the host on the USB. A portion of the host function is realized by software such as the OS or the printer driver.

A central control unit 111 controls the other functional units in the PC 102. Main functions of a central processing unit (CPU) included in the PC 102 correspond to the central processing unit 111. A print setting input operation unit 112 controls various inputting devices such as a mouse and a keyboard, and inputs various types of information to the PC 102.

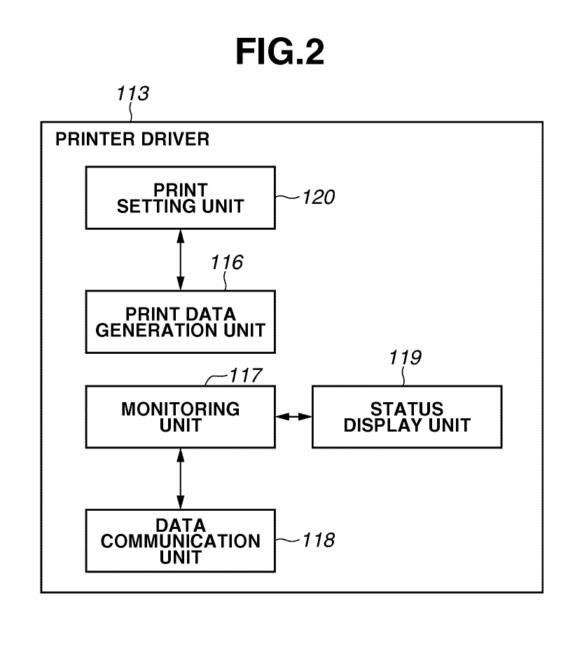

A printer driver 113 is software for performing designation of the setting values of the print setting items, generation of the print data, and control of the printer 101 on the PC 102. The printer driver 113 will be described in detail below with reference to FIG. 2.

A print spooler 114 sequentially stores the print data generated by a print data generation unit 116 to be described below, and notifies the printer driver 113 of a request to transfer (i.e., transmit) the stored print data to the printer 101. According to the present exemplary embodiment, the print spooler 114 asynchronously stores and transfers the print data. In other words, the print data generation unit 116 is capable of generating the print data without waiting for printing in the printer 101 even if the print data generation unit 116 generates the print data at higher speed than the printer 101 prints the print data. Printing is thus efficiently performed.

The print data stored in the print spooler 114 is transferred to the printer 101 according to a predetermined order. However, if the printer 101 is not switched on, or if communication is suspended, the print data is not correctly transferred, so that an error may occur in the job of the print data.

In such a case, the user operates the input device to select and instruct deletion of the job on a display screen displaying the jobs. The user can thus cancel the process and delete the print data from the print spooler 114. Generally, the print spooler 114 is provided as a function of the OS.

An application 115 is software used by the user to create and edit the document to be printed. When the user creates and edits a document using the application 115, the user can use various types of image data. However, there are contents among such image data to which there is a restriction on the number of times of printing. For example, a content in which payment of a fee is necessary (hereinafter referred to as charged content) is one of such contents.

Further, the application 115 is designed so that it cannot instruct printing of the document including such charged content to exceed the predetermined number of times of printing.

The communication interface 100 connects the PC 102 and the printer 101. The communication interface 100 realizes bidirectional communication, and may be wired or wireless connection.

The communication interface 100 may correspond to one of a plurality of types of the standards. According to the present exemplary embodiment, the USB which is a serial interface standard is assumed as the standard of the communication interface 100. The serial interface standards also include Institute of Electrical and Electronics Engineers (IEEE) 1394, Ethernet (registered trademark), infrared communication standard defined by Infrared Data Association (IrDA), IEEE802.11, and power line standard. In addition, the parallel interface standards include Centronics standard and small computer system interface (SCSI) standard.

The printer 101 also includes devices such as a CPU, a random access memory (RAM), a read-only memory (ROM), an external memory, and an input/output device (not illustrated). Further, the PC 102 includes the devices such as the CPU, a RAM, a ROM, an external memory, the input device, and a display device. For example, the external memory includes a hard disk drive (HDD) and a flexible disk (FD). The RAM and the external memory are examples of a storing unit for storing various types of information.

The present exemplary embodiment is not limited to the above-described configuration. For example, according to the present exemplary embodiment, the PC 102 and the printer 101 are connected by an interface that is capable of realizing bidirectional communication. However, a single device including the functions of the PC 102 and the printer 101 may be employed.

FIG. 2 illustrates an example of an internal configuration of the printer driver 113. Referring to FIG. 2, a print setting unit 120 has functions of displaying and notifying of the setting values of the print setting items, and receives an instruction or an input in response to a user operation on the input device. Further, the print setting unit 120 stores the print setting information including the received setting values with respect to a sheet and print quality in the external memory and manages it.

The print data generation unit 116 generates the print data according to the set print setting information, the document data generated by the application, and a print profile. The print data generation unit 116 then spools the generated print data in the print spooler 114. According to the present exemplary embodiment, the print profile includes various types of information for controlling printing on the printer 101. More specifically, the print profile includes information such as an available type of ink, an ink discharge amount, a number of scan paths of an inkjet printer head, resolution, and quality.

A monitoring unit 117 analyzes, in response to a transfer request from the print spooler 114, the print data stored in the print spooler 114. At the same time, the monitoring unit 117 sequentially transfers the print data from a data communication unit 118 to be described below to the printer 101 via the I/F control unit 110.

Further, the monitoring unit 117 acquires the status information from the printer 101. The monitoring unit 117 then transfers the acquired status information to a status display unit 119 to be described below, and the status display unit 119 displays a screen based on the received status information. Furthermore, if a page is not printed due to an error while printing by the printer, the monitoring unit 117 performs an error recovery process by transmitting again the print data of the page to the printer 101 and causing the printer 101 to print it.

The data communication unit 118 communicates with the printer 101 via the I/F control unit 110 according to the instruction from the monitoring unit 117. Examples of communication with the printer 101 are transfer of data such as the print data to the printer 101, and acquisition of the status information of the printer 101 from the printer 101.

The status display unit 119 receives and interprets the status information that the monitoring unit 117 acquired from the printer 101, and displays the screen according to the content.

### <Document Editing and Printing Process>

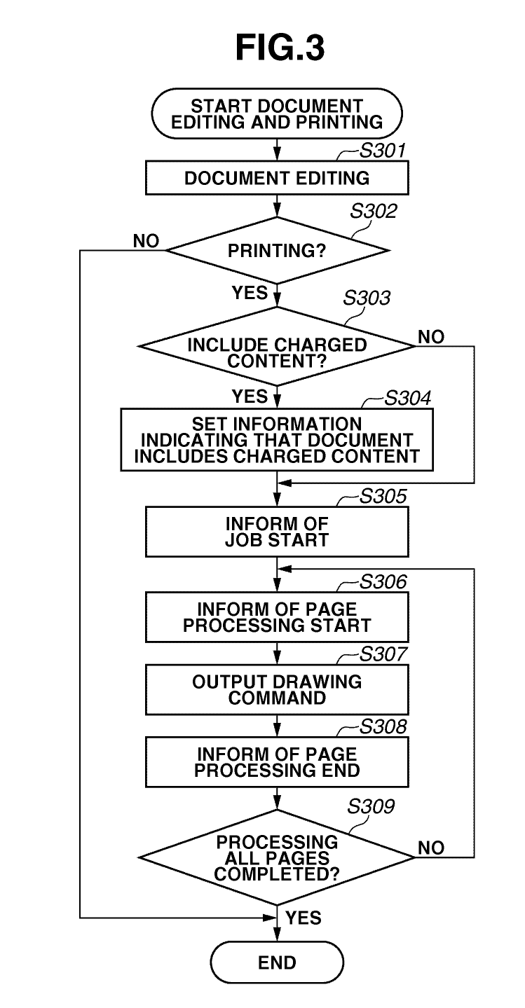

FIG. 3 is an example of a flowchart illustrating the document editing and printing process performed by the application 115. For example, the processes illustrated in the flowchart can be realized by the CPU in the PC 102 reading and executing the program related to the document editing and printing process. When the document editing and printing process is started, the user can edit a document.

In step S301, the application 115 receives a user operation for editing the document, i.e., a series of operations for instructing printing after receiving various inputs to be used for printing. More specifically, the various inputs to be used for printing includes designation of the setting values of the print setting items such as a paper size, selection and arrangement of image data, and input of text data and graphic data.

For example, the user may select as the image data, an original content such as a content on which payment is not necessary (hereinafter referred to as free content), or a charged content. Further, the user can include both the free content and the charged content in one document.

If the user selects the charged content, the application 115 refers to a content information database (not illustrated) for whether the charged content has already been printed a predetermined number of times. The content information database may be included in the PC 102, or in another computer connected to be communicable with the PC 102.

If the application 115 determines that the predetermined number of times of printing will be exceeded by printing the document being edited, the application 115 operates not to authorize a print instruction operation (i.e., a print operation). If the application 115 authorizes the print operation, the application 115 updates the information about the number of printing in the content information database.

In step S302, the application 115 determines whether there is a user operation for performing printing. If the application 115 determines that there is a user operation for performing printing (YES in step S302), the process proceeds to step S303. On the other hand, if the application 115 determines that there is no user operation for performing printing (NO in step S302), the process ends.

In step S303, the application 115 sequentially calls application program interfaces (API) related to printing, provided by the OS, and acquires a drawing command (i.e., drawing information) for each page in the document. The application 115 then determines whether the document includes a charged content. More specifically, the application 115 monitors the content selection operation and determines whether the document includes the charged content. The application 115 may also determine by other methods.

If the application 115 determines that the document includes the charged content (YES in step S303), the process proceeds to step S304. If the application 115 determines that the document does not include the charged content (NO in step S303), the process proceeds to step S305.

In step S304, the application 115 sets the information indicating that the document includes the charged content (i.e., charge information, as a part of the print setting information in advance of output of the drawing command.

In step S305, the application 115 notifies the printer driver 113 of job start.

In step S306, the application 115 notifies the printer driver 113 of page processing start. In step S307, the application 115 then outputs to the printer driver 113 a command to draw the image data, the text data, and the graphic data in the page. In step S308, the application 115 notifies the printer driver 113 of end of the page processing.

In step S309, the application 115 determines whether processing is completed for all of the pages in the document. If the application 115 determines that the processing is completed for all of the pages (YES in step S309), the process ends. On the other hand, if the application 115 determines that the processing is not completed for all of the pages (NO in step S309), the process returns to step S306. In other words, if the document includes a plurality of pages, the application 115 repeatedly performs the processes in step S306 to step S308 for the number of pages.

### <Printing Process>

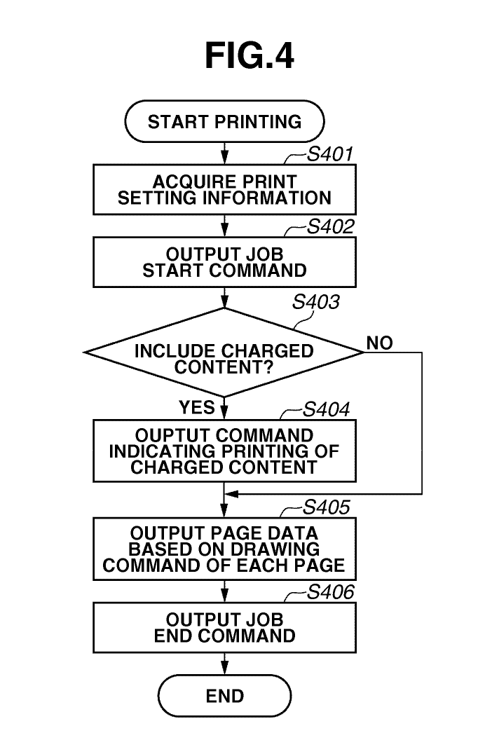

FIG. 4 is an example of a flowchart illustrating the printing process performed by the printer driver 113. For example, the processes illustrated in the flowchart can be realized by the CPU in the PC 102 reading and executing the program related to the printing process. When the application 115 receives the user operation for performing printing, the printer driver 113 is called from the OS, and the printing process is started.

In step S401, the printer driver 113 acquires the print setting information set to the job. In step S402, the printer driver 113 outputs a job start command to the print spooler 114.

In step S403, the printer driver 113 determines whether the job is with respect to the print data including a charged content by referring to charge information which can be set to the print setting information acquired in step S304. If the printer driver 113 determines that the job is with respect to the print data including the charged content (YES in step S403), the process proceeds to step S404. If the printer driver 113 determines that the job is not with respect to the print data including the charged content (NO in step S403), the process proceeds to step S405.

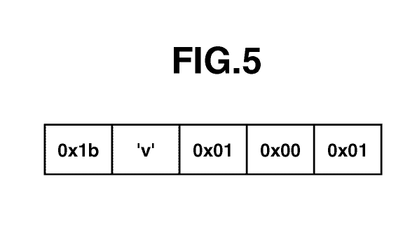

In step S404, the printer driver 113 outputs to the print spooler 114 a command indicating that the print data includes the charged content. The print spooler 114 thus stores as the print data, the command output from the printer driver 113 indicating that the print data includes the charged content. Such a command is an example of identification information indicating that the print data includes the charged content and has a structure as illustrated in FIG. 5.

FIG. 5 illustrates an example of the command indicating that the print data includes the charged content and to be transferred from the PC 102 to the printer 101.

Referring to FIG. 5, the first byte is an escape code indicating start of an escape sequence. The second byte is a value indicating a character representing the type of the command. According to the present exemplary embodiment, ‘v’ which means a command indicating whether the charged content is included is set to the second byte. The third and fourth bytes are count values of a size of the command, arranged in the order of a lower one byte and an upper one byte. In the example illustrated in FIG. 5, the count value indicates 0x0001. The fifth byte (i.e., the last byte) is a value indicating whether the charged content is included. “0x01” is a value indicating that the charged content is included.

In step S405 illustrated in FIG. 4, the printer driver 113 converts (i.e., rasterizes) the drawing command of each page into raster data, and outputs to the print driver 114 page data (i.e., a portion of the print data) which is the raster data converted to a command format.

In step S406, if the page data of all pages is output in the process in step S405, the printer driver 113 outputs a job end command to the print spooler 114. The process then ends.

### <Data Transfer Process>

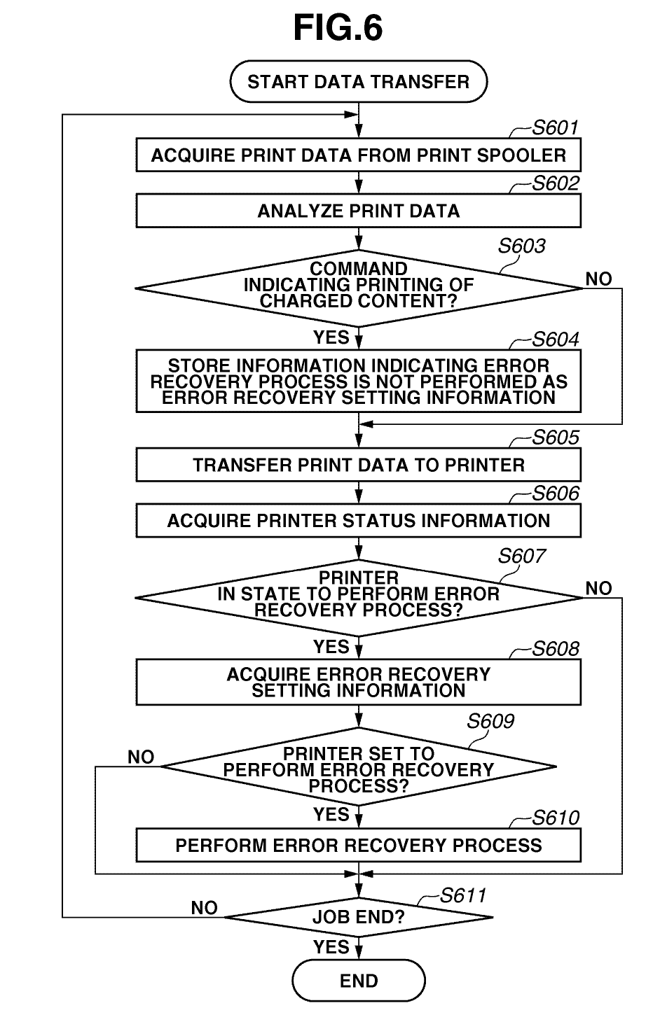

FIG. 6 is an example of a flowchart illustrating the data transfer process performed by the printer driver 113. The data transfer process is performed by the printer driver 113 in response to a transfer request received from the print spooler 114. For example, the processes illustrated in the flowchart can be realized by the CPU in the PC 102 reading and executing the program related to the data transfer process. When the printer driver 113 outputs the print data to the print spooler 114 based on the job, the print spooler 114 requests the print driver 113 to transfer the print data to the printer 101.

In step S601, upon receiving from the print spooler 114 the request to transfer the print data, the printer driver 113 acquires the print data from the print spooler 114.

In step S602, the printer driver 113 analyzes the print data acquired in step S601. In step S603, the printer driver 113 determines whether the print data includes a command indicating that the print data includes the charged content.

If the printer driver 113 determines that the print data includes the command indicating that the print data includes the charged content (YES in step S603), the process proceeds to step S604. If the printer driver 113 determines that the print data does not include such a command (NO in step S603), the process proceeds to step S605.

In step S604, the printer driver 113 stores information indicating that the job will not perform an error recovery process (i.e., non-authorization information) as error recovery setting information in a storing unit.

The error recovery setting information is initialized at the start of each job, i.e., before the job is started, by information indicating that the error recovery process will be performed (i.e., authorization information). The error recovery setting information is an example of determination information indicating whether a reprinting process is authorized to perform reprinting when an error has occurred in the job.

In step S605, the printer driver 113 transfers to the printer 101 the print data acquired from the print spooler 114 in step S601.

In step S606, the printer driver 113 requests the printer 101 to transmit the status information, and acquires the status information of the printer 101.

In step S607, the printer driver 113 analyzes the acquired status information and determines whether the printer 101 is in a state in which it is necessary to perform the error recover process. If the printer driver 113 determines that the printer 101 is in a state in which it is necessary to perform the error recover process (YES in step S607), the process proceeds to step S608. On the other hand, if the printer driver 113 determines that the printer 101 is not in such a state (NO in step S607), the process proceeds to step S611.

In step S608, the printer driver 113 acquires the error recovery setting information. In step S609, the printer driver 113 determines whether the error recovery setting information is the authorization information. If the printer driver 113 determines that the error recovery setting information is the authorization information (YES in step S609), the process proceeds to step S610. If the printer driver 113 determines that the error recovery setting information is the non-authorization information (NO in step S609), the process proceeds to step S611. In step S610, the printer driver 113 performs the error recovery process. The process then proceeds to step S611.

According to the present exemplary embodiment, it is assumed that the error recovery process is a method in which the print driver 113 retransmits the necessary print data. However, the present invention is not limited to the above-described method. For example, it may be a method in which the printer 101 includes an error recovery function, and the printer driver 113 can issue an instruction to execute the error recovery process based on a command. Further, any method may be employed for performing control from the printer driver 113.

In step S611, the printer driver 113 determines whether the job ends. If the printer driver 113 determines that the job ends (YES in step S611), the process ends. If the printer driver 113 determines that the job does not end (NO in step S611), the process returns to step S601. In other words, the printer driver 113 thus repeats the process from step S601 to step S610 until transmission of all of the print data pieces requested to be transferred from the print spooler 114 is completed, and then ends the data transfer process.

According to the above-described exemplary embodiment, the printer 101 can be controlled so as not to perform the error recovery process when the print data of the job includes the charged content, even if the printer 101 is in a state in which it is necessary to perform the error recovery process, such as an occurrence of a paper jam error. Further, according to the above-described exemplary embodiment, printing of the charged content can be prevented from being printed in excess of the restricted number of times of printing due to performing the error recovery process. Furthermore, according to the above-described exemplary embodiment, the document including the charged content can be edited, so that versatility is improved.

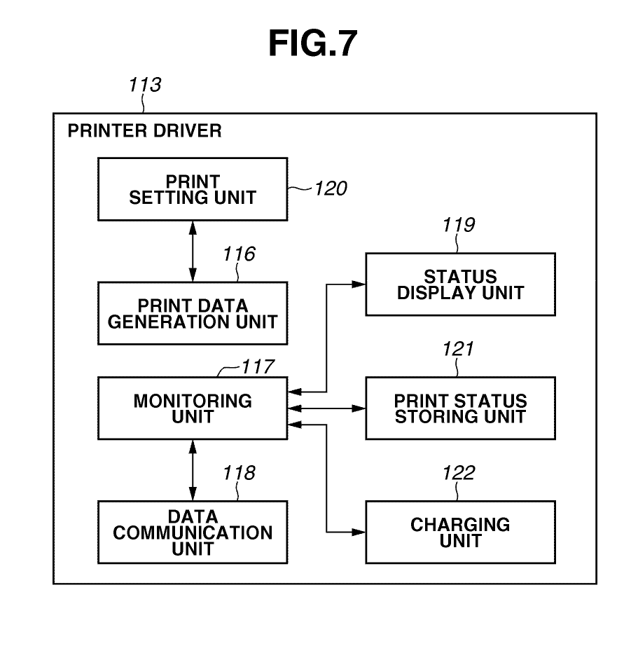

A second exemplary embodiment will be described with reference to FIGS. 7 to 16. According to the present exemplary embodiment, the configurations similar to those of the first exemplary embodiment will be assigned the same reference numerals, and description thereof will be omitted.

FIG. 7 illustrates an example of the internal configuration of the printer driver 113 according to the present exemplary embodiment. Referring to FIG. 7, a print status storing unit 121 stores print statuses of the charged content in each job. A charging unit 122 performs a charging process according to a print result of the charged content at the end of each job. Since the other functional units (116 to 120) are similar to the functional units (116 to 120) illustrated in FIG. 2, description thereof will be omitted.

### <Document Editing and Printing Process>

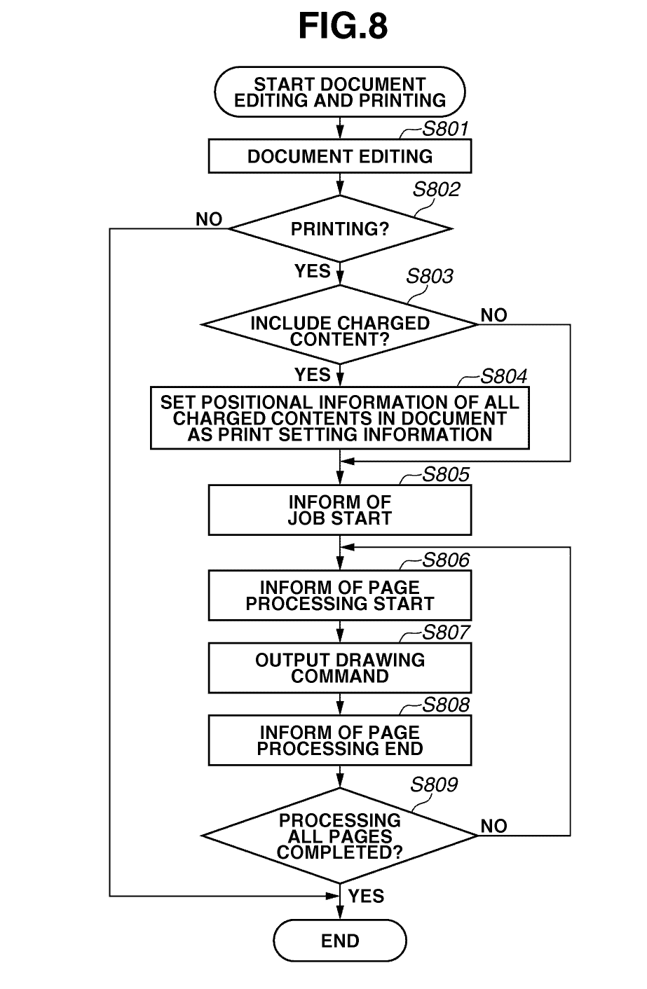

FIG. 8 is an example of a flowchart illustrating the document editing and printing process performed by the application 115. Since the processes in step S801 to step S803 and step S805 to step S809 are similar to the processes in step S301 to step S303 and step S305 to step S309 illustrated in FIG. 3, description thereof will be omitted.

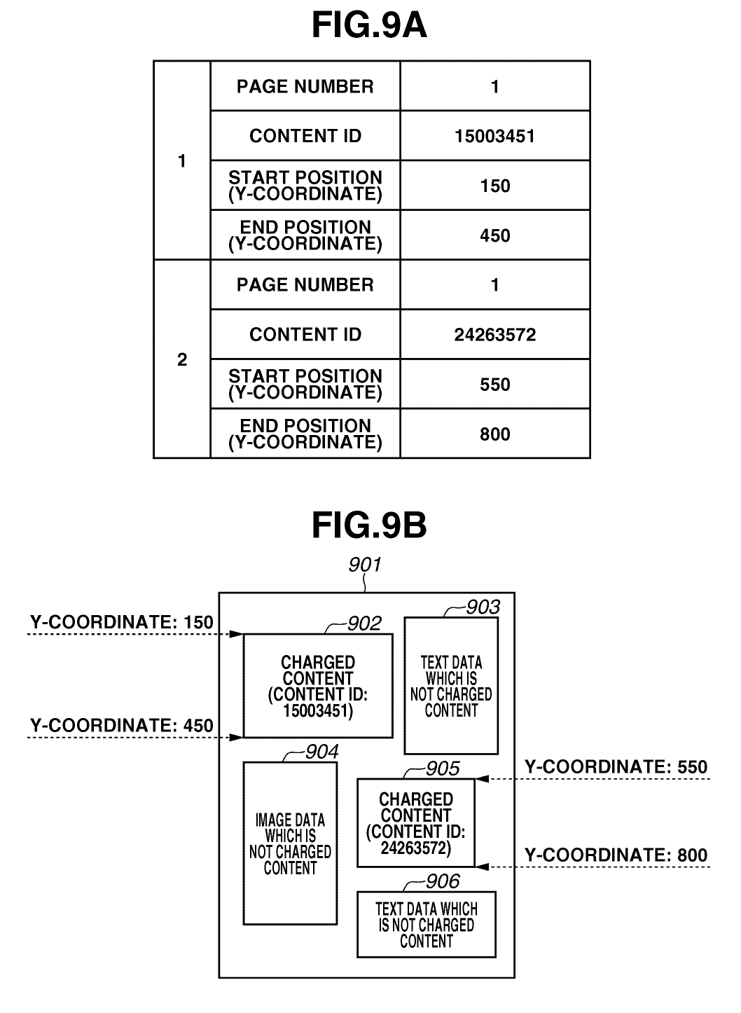

In step S804, the application 115 sets as a part of the print setting information, positional information pieces of all charged contents in the document along with a page number and a content identification (ID). The information to be set is structured as illustrated in FIG. 9A.

FIG. 9A illustrates an example of the positional information of the charged contents set as the print setting information by the application 115. FIG. 9B illustrates an example of an arrangement of the charged contents in the page according to FIG. 9A.

Referring to FIG. 9A, a page number indicates the page in the document in which the charged content is arranged. A content ID indicates a unique identification (ID) number of the charged content. A start position (Y-coordinate) indicates a distance from an upper end of a sheet to an upper end of the charged content. An end position (Y-coordinate) indicates the distance from the upper end of the sheet to a lower end of the charged content.

Referring to FIG. 9B, each of charged contents 902 and 905 is arranged in a page 901 at the position recorded in FIG. 9A. Further, free contents 903, 904, and 906 are arranged in the page 901.

### <Data Transfer Process>

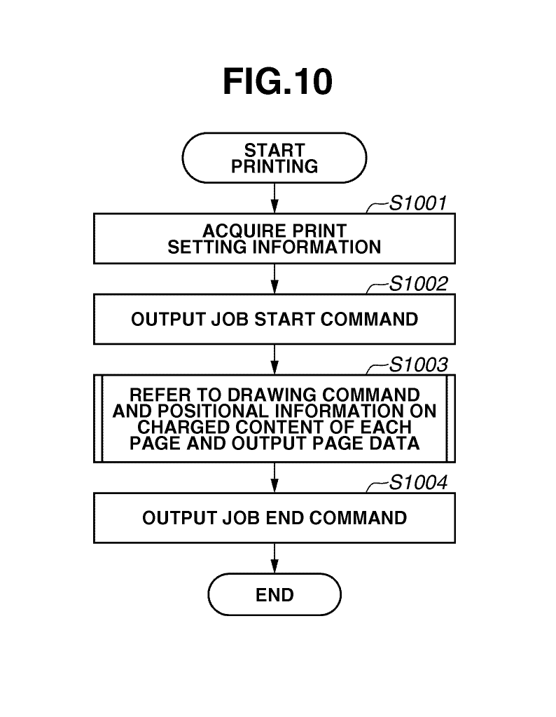

FIG. 10 is an example of a flowchart illustrating the printing process performed by the printer driver 113. When the application 115 receives the user operation to perform printing, the printer driver 113 is called from the OS, and the printing process is started.

In step S1001, the printer driver 113 acquires the print setting information set to the job. The print setting information includes the positional information of the charged content set in step S804 illustrated in FIG. 8. In step S1002, the printer driver 113 outputs to the print spooler 114 the job start command.

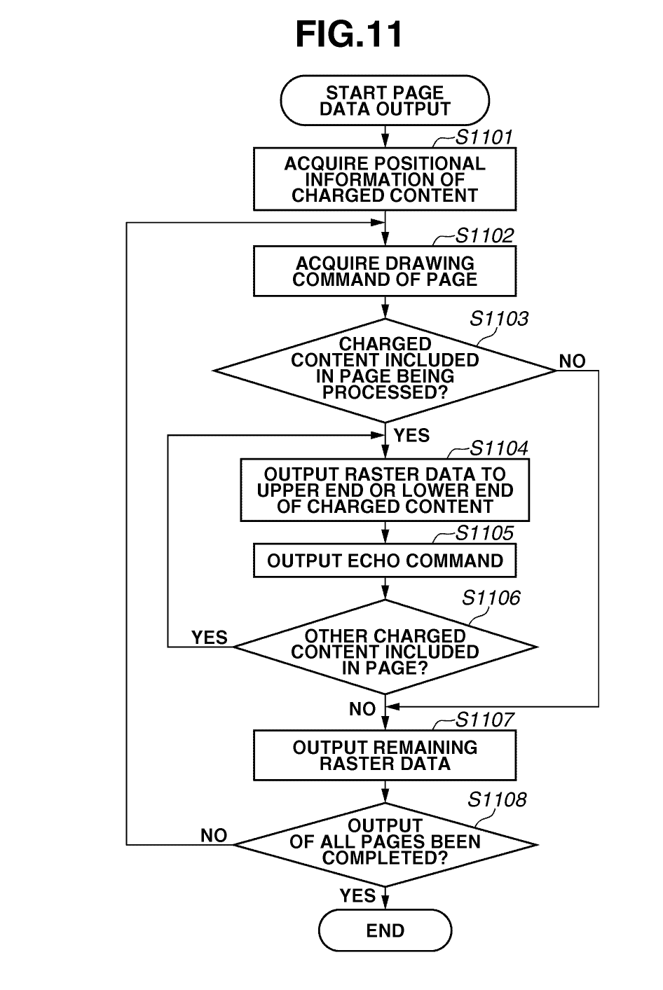

In step S1003, the printer driver 113 outputs the page data to the print spooler 114 (i.e., performs a page data output process) by referring to the positional information of the charged content in the print setting information acquired in step S1001. The page data output process will be described in detail below with reference to FIG. 11.

In step S1004, the printer driver 113 outputs the job end command to the print spooler 114, and the printing process ends.

FIG. 11 is an example of a flowchart illustrating the page data output process performed by the printer driver 113. The page data output process is performed as a part of the printing process of the printer driver 113.

In step S1101, the printer driver 113 refers to the print setting information acquired in step S1001 illustrated in FIG. 10 and acquires the positional information of the charged content. In step S1102, the printer driver 113 acquires a drawing command of the page.

In step S1103, the printer driver 113 refers to, when converting (i.e., rasterizing) the drawing command to the raster data, the positional information of the charged content acquired in step S1101, and determines whether the page being processed includes the charged content. If the printer driver 113 determines that the page being processed includes the charged content (YES in step S1103), the process proceeds to step S1104. On the other hand, if the printer driver 113 determines that the page being processed does not include the charged content (NO in step S1103), the process proceeds to step S1107.

In step S1104, the printer driver 113 outputs to the print spooler 114, the raster data of the charged content in the page, to immediately before the upper end of the charged content, or the lower end of the charged content. In step S1105, the printer driver 113 outputs to the print spooler 114 the command indicating the position of the charged content (hereinafter referred to as an echo command).

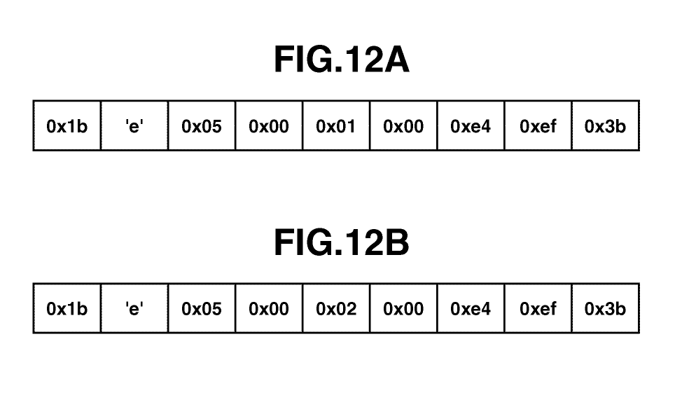

For example, if the printer driver 113 has output the raster data to immediately before the upper end of the charged content, the printer driver 113 outputs to the print spooler 114 the echo command illustrated in FIG. 12A. Further, for example, if the printer driver 113 has output the raster data to the lower end of the charged content, the printer driver 113 outputs the echo command illustrated in FIG. 12B to the print spooler 114.

FIGS. 12A and 12B illustrate examples of the echo command. The echo command illustrated in FIG. 12A is output immediately before the printer driver 113 outputs the raster data of the upper end of the charged content whose content ID is 15003451 (00e4ef3b in hexadecimal notation). The echo command illustrated in FIG. 12B is output immediately after the printer driver 113 outputs the raster data of the lower end of the charged content whose content ID is 15003451 (00e4ef3b in hexadecimal notation).

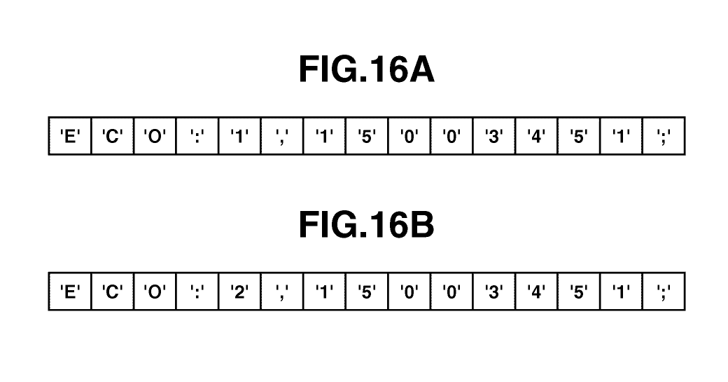

According to the present exemplary embodiment, upon receiving and processing the print data including the above-described echo commands, the printer 101 transmits to the PC 102 a response command to be described below with reference to FIGS. 16A and 16B. More specifically, the printer 101 transmits the response command immediately before (or immediately after) the printer 101 prints the raster data with respect to the echo command which is output immediately before (or immediately after) the raster data. As a result, the PC 102 which receives the response command can recognize start and end of printing of the charged content.

In step S1106 illustrated in FIG. 11, the printer driver 113 determines whether there are other charged contents included in the page. If the printer driver 113 determines that the other charged contents are included in the page (YES in step S1106), the process returns to step S1104. If the printer driver 113 determines that no other charged contents are included in the page (NO in step S1106), the process proceeds to step S1107.

In step S1107, the printer driver 113 outputs the remaining raster data to the print spooler 114 and thus ends the process of outputting the data for one page (i.e., page data).

In step S1108, the printer driver 113 determines whether output of the page data is completed for all pages. If the printer driver 113 determines that the page data of all pages has been output (YES in step S1108), the process ends. If the printer driver 113 determines that the page data of all pages has not been output (NO in step S1108), the process returns to step S1102.

### <Data Transfer Process>

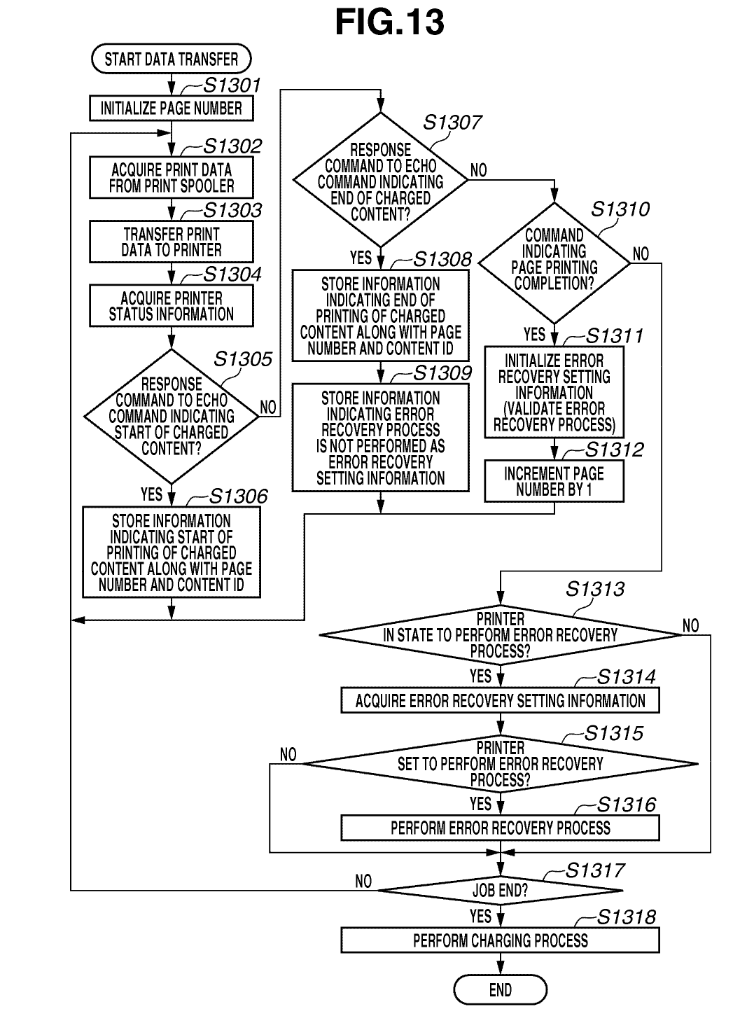

FIG. 13 is an example of a flowchart illustrating the data transfer process performed by the printer driver 113. The data transfer process is performed by the printer driver 113 in response to a transfer request from the print spooler 114. When the printer driver 113 outputs the print job to the print spooler 114, the print spooler 114 requests the print driver 113 to transfer the print data to the printer 101.

In step S1301, upon receiving the request to transfer the print data from the print spooler 114, the printer 113 initializes processing page information to be stored as the current page number to a content indicating the first page.

In step S1302, the printer driver 113 acquires the print data from the print spooler 114. In step S1303, the printer driver 113 transfers the acquired print data to the printer 101. In such a case, the printer driver 113 transmits to the printer 101 a request to receive the print data.

In step S1304, the printer driver 113 requests the printer 101 to transmit the status information and acquires the status information of the printer 101.

In step S1305, the printer driver 113 analyzes the acquired status information and determines whether the status information includes the response command illustrated in FIG. 16A which is transmitted immediately before printing of the charged content is started. If the printer driver 113 determines that the status information includes such response command (YES in step S1305), the process proceeds to step S1306. If the printer driver 113 determines that the status information does not include such response command (NO in step S1305), the process proceeds to step S1307.

In step S1306, the printer driver 113 stores in the storing unit, the information indicating that the printer 101 will start printing the charged content along with the page number of the page being processed and the content ID. The process then returns to step S1302, and the printer driver 113 acquires the subsequent print data.

In step S1307, the printer driver 113 determines whether the acquired status information includes the response command illustrated in FIG. 16B which is an example of end information transmitted immediately after printing the charged content. If the printer driver 113 determines that the acquired status information includes such response command (YES in step S1307), the process proceeds to step S1308. If the printer driver 113 determines that the acquired status information does not include such response command (NO in step S1307), the process proceeds to step S1310.

In step S1308, the printer driver 113 stores in the storing unit, the information indicating that the printer 101 completes printing of the charged content along with the page number of the page being processed and the content ID. In other words, the printer driver 113 stores in the storing unit, identification information by which the printed content can be identified.

In step S1309, the printer driver 113 stores the information indicating that the error recovery process is not performed on the current page (i.e., non-authorization information) as the error recovery setting information in the storing unit. The process then returns to step S1302, and the printer driver 113 acquires the subsequent print data. The error recovery setting information is initialized at the start of each job, i.e., before the job is started, by information indicating that the error recovery process will be performed (i.e., authorization information).

In step S1310, the printer driver 113 determines whether the status information includes the command indicating that the printer 101 completed printing the page. If the printer driver 113 determines that the status information includes such a command (YES in step S1310), the process proceeds to step S1311. If the printer driver 113 determines that the status information does not include such a command (NO in step S1310), the process proceeds to step S1313.

In step S1311, the printer driver 113 initializes the error recovery setting information, i.e., stores the error recovery setting information as the authorization information. In step S1312, the printer driver 113 adds one to the processing page information stored in the storing unit (i.e., more narrowly a storage area of the printer driver 113). The process then returns to step S1302, and the printer driver 113 acquires the subsequent print data.

In step S1313, the printer driver 113 determines whether the status information includes the command indicating the state that it is necessary to perform the error recovery process. If the printer driver 113 determines that the status information includes such a command (YES in step S1313), the process proceeds to step S1314. If the printer driver 113 determines that the status information does not include such a command (NO in step S1313), the process proceeds to step S1317.

In step S1314, the printer driver 113 acquires the error recovery setting information. In step S1315, the printer driver 113 determines whether the error recovery setting information is the authorization information. If the printer driver 113 determines that the error recovery setting information is the authorization information (YES in step S1315), the process proceeds to step S1316. If the printer driver 113 determines that the error recovery setting information is the non-authorization information (NO in step S1315), the process proceeds to step S1317. In step S1316, the printer driver 113 performs the error recovery process.

In step S1317, the printer driver 113 determines whether the job has ended. If the printer driver 113 determines that the job has ended (YES in step S1317), the process proceeds to step S1318. If the printer driver 113 determines that the job has not ended (NO in step S1317), the process returns to step S1302.

In step S1318, the printer driver 113 performs the charging process, and the process ends. More specifically, after repeating the processes in step S1302 to step S1316 until printing of the entire job is completed, the printer driver 113 refers to the information about the charged content that has been printed, which is stored in step S1308, and performs the charging process with respect to the charged content that has been printed.

### <Data Receiving Process and Print Execution Process>

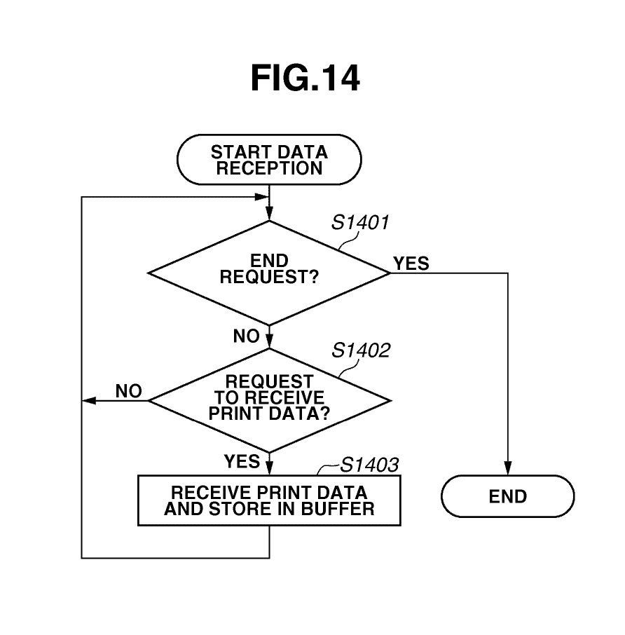

FIG. 14 is an example of a flowchart illustrating a data receiving process performed by the printer 101. The data receiving process is performed by the I/F control unit 103 in the printer 101.

In step S1401, the printer 101 determines whether an end request of the printer 101, which is generated by the user switching off the printer 101, is detected. If the printer 101 determines that the end request is detected (YES in step S1401), the process ends. Whereas if the printer 101 determines that the end request is not detected (NO in step S1401), the process proceeds to step 1402.

In step S1402, the printer 101 determines whether the printer 101 has received the print data receiving request from the PC 102. If the printer 101 determines that the printer 101 has received the request (YES in step S1402), the process proceeds to step S1403. If the printer 101 determines that the printer 101 has not received the request (NO in step S1402), the process returns to step S1401.

In step S1403, the printer 101 receives the print data and stores it in a buffer. Since there is a limit to the buffer capacity, if the print data requested to be received cannot be stored in the buffer, the printer 101 notifies the PC 102 transmitting the print data of an error and prompts the PC 102 to perform retransmission. The printer 101 repeats the above-described process until the end request is detected.

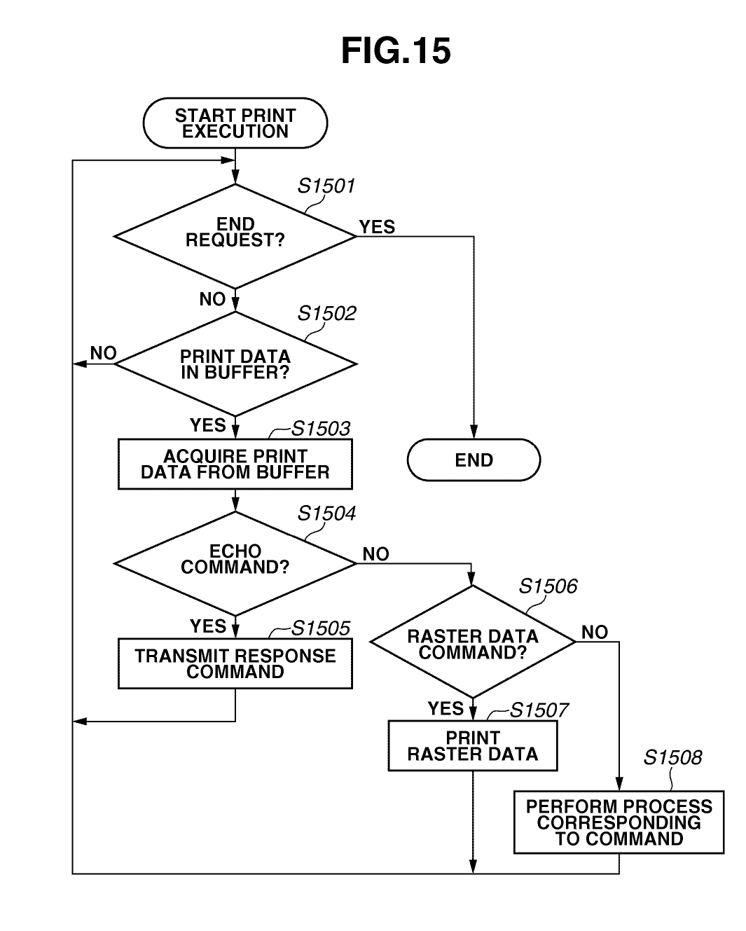

FIG. 15 is an example of a flowchart illustrating a print execution process performed by the printer 101. The print execution process is performed by the print control unit 104 and the printing unit 105 in the printer 101.

In step S1501, the printer 101 determines whether the end request is detected. If the printer 101 determines that the end request is detected (YES in step S1501), the process ends. If the printer 101 determines that the end request is not detected (NO in step S1501), the process proceeds to step S1502.

In step S1502, the printer 101 determines whether the print data is stored in the buffer. If the printer 101 determines that the print data is stored in the buffer (YES in step S1502), the process proceeds to step S1503. If the printer 101 determines that the print data is not stored in the buffer (NO in step S1502), the process returns to step S1501.

In step S1503, the printer 101 acquires the print data from the buffer. More specifically, when the print data is stored in the buffer, the printer 101 acquires the print data from the buffer by the commands and analyzes the contents.

In step S1504, the printer 101 determines whether the command in the print data acquired from the buffer is the echo command. If the printer 101 determines that the command in the print data is the echo command (YES in step S1504), the process proceeds to step S1505. If the printer 101 determines that the command in the print data is not the echo command (NO in step S1504), the process proceeds to step S1506.

In step S1505, the printer 101 generates the response command in a format illustrated in FIGS. 16A and 16B, based on the information designated by the echo command, and transmits the response command to the PC 102.

According to the present exemplary embodiment, the information of the echo command in the hexadecimal notation is converted to decimal notation and then to an American National Standard Code for Information Interchange (ASCII) code. The converted information of the echo command is thus transmitted as a character string. However, the present invention is not limited to the above-described configuration. For example, the information may be transmitted in other form, such as directly as binary data. Upon transmitting the response command, the printer 101 performs the process in step S1501 to acquire the subsequent command from the buffer.

FIGS. 16A and 16B illustrate examples of the response commands transmitted from the printer 101 with respect to the echo commands illustrated in FIGS. 12A and 12B. The echo command illustrated in FIG. 16A is transmitted immediately before the printer 101 starts printing the charged content whose content ID is 15003451. The echo command illustrated in FIG. 16B is transmitted immediately after the printer 101 completes printing of the charged content whose content ID is 15003451.

In step S1506, the printer 101 determines whether the command is a raster data command. If the printer 101 determines that the command is a raster data command (YES in step S1506), the process proceeds to step S1507. If the printer 101 determines that the command is not a raster data command (NO in step S1506), the process proceeds to step S1508.

In step S1507, the printer 101 prints the raster data using the printing unit 105. The process then returns to step S1501, and the printer 101 acquires the subsequent command from the buffer.

In step S1508, the printer 101 executes the process designated by the command. Examples of commands other than the echo command or the raster command is a sheet feed bin selection command, a maintenance command instructing cleaning of the print head, or the like. The process then returns to step S1501, and the printer 101 acquires the subsequent command from the buffer.

As described above, the printer 101 sequentially prints the raster data included in the print data received in PC 102. At the same time, the printer 101 transmits the response commands to the echo commands inserted before and after the charged content included between the raster data pieces.

According to the above-described configuration, the PC 102 can transmit the response command immediately before printing of the charged content and immediately after the completion of the printing, so that the PC 102 can recognize the start and the end of the printing of the charged content.

As a result, if there is at least one charged content included in each page which has been printed, control can be performed so that the error recovery process with respect to the page is not executed. It can thus prevent the charged content from being printed in excess of the restricted number of times of printing by execution of the error recovery process.

Further, the charging process with respect to printing of the charged content can be performed based on whether printing of each of the contents is completed. The charging process can thus be appropriately performed even when there is an error in printing.

In other words, according to the present exemplary embodiment, the user can freely create a document including a content whose number of times of printing is restricted. Further, the charging process and the reprinting process can be appropriately performed according to whether printing of the content is completed, even if an error has occurred while printing the document and printing has been interrupted

According to the present invention, printing of a target content whose number of times of printing is restricted can be appropriately controlled.

Aspects of the present invention can also be realized by a computer of a system or apparatus (or devices such as a CPU or an MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-084719 filed Apr. 6, 2011, which is hereby incorporated by reference herein in its entirety.

What is claimed is:

1. An information processing apparatus comprising:
a determination unit configured to determine whether print data includes identification information indicating that there is a target content to which a restriction on a number of times of printing is set;
a storing unit configured to store determination information indicating whether to authorize a reprinting process to be performed if an error occurs in printing of the print data as information indicating authorization of performing the reprinting process; and
a changing unit configured to change, if the determination unit determines that the identification information is included, the determination information to information indicating not authorizing the reprinting process.

2. The information processing apparatus according to claim 1, wherein the information processing apparatus is connected to be communicable with a printing apparatus configured to print the print data,
the information processing apparatus further comprising a print control unit configured to acquire information about whether there is an error in printing of the print data from the printing apparatus, to perform the reprinting processing if it is determined that there is an error and if the determination information indicates authorizing the reprinting process, and not to perform the reprinting process if it is determined that there is an error and if the determination information indicates not authorizing the reprinting process.

3. An information processing apparatus comprising:
a generation unit configured to generate, if print data is generated based on a print job to an end of a target content to which a restriction on a number of times of printing is set, information indicating an end of the content; and
a storing unit configured to store determination information indicating whether to authorize a reprinting process to be performed for reprinting if an error occurs in the print job as information indicating authorization of the reprinting process in a storage unit before the job is started, and to change, if end information, which indicates that printing of the content is ended and is transmitted when a printing apparatus determines that printing of the content is ended based on information indicating end of the content, is received from the printing apparatus, the determination information to information indicating not authorizing the reprinting process.

4. The information processing apparatus according to claim 3, further comprising a print control unit configured to acquire information about whether there is an error in printing of the print data from the printing apparatus, to perform the reprinting processing if it is determined that there is an error and if the determination information indicates authorizing the reprinting process, and not to perform the reprinting process if it is determined that there is an error and if the determination information indicates not authorizing the reprinting process.

5. The information processing apparatus according to claim 4, wherein, if information indicating that printing of a first page of the print data is ended is received from the printing apparatus, the storing unit further changes the determination information to information indicating authorization of the reprinting process, and
wherein, if the determination information is information indicating not authorizing the reprinting process, the print control unit does not perform the reprinting process with respect to a page including the content.

6. The information processing apparatus according to claim 3, wherein, if the end information is received from the printing apparatus, the storing unit further stores identification information by which the content can be identified, and
the information processing apparatus further comprising a charging unit configured to charge, if the job has ended, for the content according to the identification information.

7. A method for performing print control, the method comprising:
determining whether print data includes identification information indicating that there is a target content to which a restriction on a number of times of printing is set;
storing determination information indicating whether to authorize a reprinting process to be performed if an error occurs in printing of the print data as information indicating authorization of performing the reprinting process; and
changing, if it is determined that the identification information is included, the determination information to information indicating not authorizing the reprinting process.

8. A method for performing print control in an information processing apparatus, the method comprising:
generating, if print data is generated based on a print job to an end of a target content to which a restriction on a number of times of printing is set, information indicating an end of the content; and
storing determination information indicating whether to authorize a reprinting process to be performed for reprinting if an error occurs in the print job as information indicating authorization of the reprinting process in a storage unit before the job is started, and changing, if end information, which indicates that printing of the content is ended and is transmitted when a printing apparatus determines that printing of the content is ended based on information indicating end of the content, is received from the printing apparatus, the determination information to information indicating not authorizing the reprinting process.

9. The method according to claim 8, further comprising acquiring information about whether there is an error in printing of the print data from the printing apparatus, performing the reprinting processing if it is determined that there is an error and if the determination information indicates authorizing the reprinting process, and not performing the reprinting process if it is determined that there is an error and if the determination information indicates not authorizing the reprinting process.

10. The method according to claim 9, further comprising:
changing, if information indicating that printing of a first page of the print data is ended is received from the printing apparatus, the determination information to information indicating authorization of the reprinting process; and
not performing, if the determination information is information indicating not authorizing the reprinting process, the reprinting process with respect to a page including the content.

11. The method according to claim 8, further comprising:
storing, if the end information is received from the printing apparatus, identification information by which the content can be identified; and
charging, if the job is ended, for the content according to the identification information.

12. A computer-readable storage medium storing a program for causing a computer to function as:
a determination unit configured to determine whether print data includes identification information indicating that there is a target content to which a restriction on a number of times of printing is set;
a storing unit configured to store determination information indicating whether to authorize a reprinting process to be performed if an error occurs in printing of the print data as information indicating authorization of performing the reprinting process; and
a changing unit configured to change, if the determination unit determines that the identification information is included, the determination information to information indicating not authorizing the reprinting process.

13. A computer-readable storage medium storing a program for causing a computer to function as:
a generation unit configured to generate, if print data is generated based on a print job to an end of a target content to which a restriction on a number of times of printing is set, information indicating an end of the content; and
a storing unit configured to store determination information indicating whether to authorize a reprinting process to be performed for reprinting if an error occurs in the print job as information indicating authorization of the reprinting process in a storage unit before the job is started, and to change, if end information, which indicates that printing of the content is ended and is transmitted when the printing apparatus determines that printing of the content is ended based on information indicating end of the content, is received from the printing apparatus, the determination information to information indicating not authorizing the reprinting process.

14. The computer-readable storage medium according to claim 13, wherein the program further causing the computer to function as a print control unit configured to acquire information about whether there is an error in printing of the print data from the printing apparatus, to perform the reprinting processing if it is determined that there is an error and if the determination information indicates authorizing the reprinting process, and not to perform the reprinting process if it is determined that there is an error and if the determination information indicates not authorizing the reprinting process.

15. The computer-readable storage medium according to claim 14, wherein the program further comprising:
changing, if information indicating that printing of a first page of the print data is ended is received from the printing apparatus, the determination information to information indicating authorization of the reprinting process; and
not performing, if the determination information is information indicating not authorizing the reprinting process, the reprinting process with respect to a page including the content.

16. The computer-readable storage medium according to claim 13, wherein the program further comprising:
storing, if the end information is received from the printing apparatus, identification information by which the content can be identified, and
the program further causing the computer to function as a charging unit configured to charge, if the job has ended, for the content according to the identification information.
